(19) United States
(12) Patent Application Publication
(10) Pub. No.: US 2003/0048421 A1
(43) Pub. Date: Mar. 13, 2003

(54) Liquid crystal projector

(76) Inventor: Alpha Du, Hsinchu city (TW)

Correspondence Address: BIRCH STEWART KOLASCH & BIRCH, PO BOX 747, FALLS CHURCH, VA, 22040-0747, US

(21) Appl. No.: 09/933,753

(22) Filed: Aug. 22, 2001

(51) Int. Cl. G03B 21/00

(52) U.S. Cl. 353/31

(57) ABSTRACT

A liquid crystal projector having increased contrast ratio and color saturation is disclosed. Due to the response of human eyes with respect to green color is much higher than that of each of red and blue colors, when the contrast ratio of green light is increased, the contrast of the system is regarded as been greatly increased. Thereby, the contrast of green light is increased by two PS polarizing beam splitters in this system, so that the contrast ration of the system can be greatly increased. Furthermore, a color selector is also utilized for selectively changing the polarization of a single color, thereby simultaneously increasing the contrasts of three colors of R, G, and B by way of three PS polarizing beam splitters.

### BACKGROUND OF THE INVENTION

1. Field of the Invention

The invention relates to a liquid crystal projector, in particular to a liquid crystal projector having an enhanced extinction ratio.

2. Description of the Related Art

FIGS. 1 and 2 are optical architecture diagrams showing the image projector in U.S. Pat. No. 5,267,029.

As shown in FIG. 1, the P-polarized white light P_{W} emitted from the polarization converting module 12 is separated into P-polarized red light P_{R}, blue light P_{B} and green light P_{G} by way of the first dichroic mirror (hereinafter referred to as the M 11. The P-polarized red light P_{R} is transmitted through the λ/2 plate 10, and is then reflected by the reflection mirror 9 to become S-polarized red light P_{S}. The S-polarized red light P_{S} travels toward the LCD 8 and is converted into the P-polarized red light P_{R}. The P-polarized green light P_{G} is reflected by the second dichroic mirror 7, travels toward the LCD 6, and is converted into the S-polarized green light S_{G}. The S-polarized green light S_{G} passing through the LCD 6 is reflected by the first polarizing beam splitter (hereinafter referred to as the “BS_{S}”) 5, while the P-polarized red light P_{R} passing through the LCD 8 transmits through the BS_{S} 5. The P-polarized blue light P_{B} transmitting through the second dichroic mirror 7 travels toward the LCD 4, and the S-polarized blue light S_{B} is then generated. The S-polarized blue light S_{B} transmits through the second beam splitter 3. Then the S-polarized light is reflected by the beam splitter 3 while the P-polarized light transmits through the beam splitter 3. Finally, the P-polarized red light P_{R} and S-polarized green light S_{G} emitted from the first beam splitter 5 transmit through the third dichroic mirror 2, while the S-polarized blue light S_{B} emitted from the second beam splitter 3 is reflected by the third dichroic mirror 2.

As shown in FIG. 2, the S-polarized white light S_{W} emitted from the polarization converting module 12 is separated into the S-polarized red light S_{R}, and the S-polarized blue light S_{B} and S-polarized green light S_{G} by the first DM 11. The S-polarized red light S_{R} is reflected by the reflection mirror 9 and becomes the S-polarized red light P_{S}. The S-polarized red light P_{S} travels toward the LCD 8 and is then converted into the P-polarized red light P_{R}. The S-polarized green light S_{G} is reflected by the second dichroic mirror 7, then travels toward the LCD 6, and is converted into the P-polarized green light P_{G}. The P-polarized green light P_{G} passing through the LCD 6 is reflected by the third dichroic mirror 15, while the P-polarized red light P_{R} passing through the LCD 8 transmits through the third dichroic mirror 15. The S-polarized blue light S_{B} transmitting through the second dichroic mirror 7 passes through the λ/2 plate 10, travels toward the LCD 4, and the S-polarized blue light S_{B} is then generated. The S-polarized blue light S_{B} is reflected by the total reflection mirror 14. Finally, the P-polarized red light P_{R} and P-polarized green light P_{G} emitted from the third dichroic mirror 15 transmits through the first beam splitter 5, while the S-polarized blue light S_{B} reflected by the total reflection mirror 14 is reflected by the first beam splitter 5.

In the optical architecture of the above-mentioned projector, however, the light paths of red light, green light and blue light all pass through one beam splitter. If the third dichroic mirror 2 in FIG. 1 is changed to be a beam splitter, or the elements 14 and 15 in FIG. 2 is changed to be a beam splitter, the optical architecture will not work properly any more.

### SUMMARY OF THE INVENTION

In view of the above-mentioned problems, it is therefore an object of the invention to provide a liquid crystal projector in which two sets of beam splitters are provided for increasing the extinction ratio.

To achieve the above-mentioned objective, the liquid crystal projector of the invention includes a beam-splitting device, a first transmission liquid crystal display module, a second transmission liquid crystal display module, a third transmission liquid crystal display module, and a beam-combining mechanism. The beam-splitting device supplies polarized lights of a red, a green, and a blue colors, which are polarized in predetermined polarization. The first transmission liquid crystal display module is to rotate the plane of polarization of the first color light in accordance with an input signal to generate a first image by the polarized light of the first color. The second transmission liquid crystal display module is to rotate the plane of polarization of the second color light in accordance with an input signal to generate a second image by the polarized light of the second color. The third transmission liquid crystal display module is to rotate the plane of polarization of the third color light in accordance with an input signal to generate a third image by the polarized light of the third color.

The beam-combining mechanism includes a first PS polarizing beam splitter, a dichroic prism, and a second PS polarizing beam splitter. The first PS polarizing beam splitter is to extract a determined polarized light from the second liquid crystal display module. The dichroic prism is disposed at a location whereat the first and third polarized light from the first and the third liquid crystal display module intersect each other for reflecting the first polarized light from the first liquid crystal display module and transmitting there-through the third polarized light from the third liquid crystal display module, to extract a determined polarized light. And the second PS polarizing beam splitter is disposed at a location whereat the polarized light from first PS polarizing beam splitter and polarized light from the dichroic prism intersect each other, to extract a determined polarized light;

Therefore, in the liquid crystal projector of the invention, the green color passes through two PS polarizing beam splitters so that the contrast ratio and color saturation of the color can be increased.

### BRIEF DESCRIPTION OF THE DRAWINGS

FIG. 1 is an optical architecture diagram showing a conventional liquid crystal projector.

FIG. 2 is an optical architecture diagram showing another conventional liquid crystal projector.

FIG. 3 is an optical architecture diagram showing a liquid crystal projector in accordance with a first embodiment of the invention.

FIG. 4 is a graph showing the relationship between the wavelength and the transmittance of the dichroic prism in FIG. 3.

FIG. 5 is a graph showing the relationship between the wavelength of the first PS polarizing beam splitter in FIG. 3 and the transmittance of the P-polarized light.

FIG. 6 is a graph showing the relationship between the wavelength of the first PS polarizing beam splitter in FIG. 3 and the transmittance of the S-polarized light.

FIG. 7 is a graph showing the relationship between the wavelength of the second PS polarizing beam splitter in FIG. 3 and the transmittance of the P-polarized light.

FIG. 8 is a graph showing the relationship between the wavelength of the second PS polarizing beam splitter in FIG. 3 and the transmittance of the S-polarized light.

FIG. 9 is an optical architecture diagram showing another liquid crystal projector in accordance with a second embodiment of the invention.

FIG. 10 is a schematic illustration showing modified arrangement architecture of the prisms of the invention.

FIG. 11 is a schematic illustration showing modified arrangement architecture of the prisms of the invention.

FIG. 12 is an optical architecture diagram showing another liquid crystal projector in accordance with a third embodiment of the invention.

FIG. 13 is an optical architecture diagram showing another liquid crystal projector in accordance with a fourth embodiment of the invention.

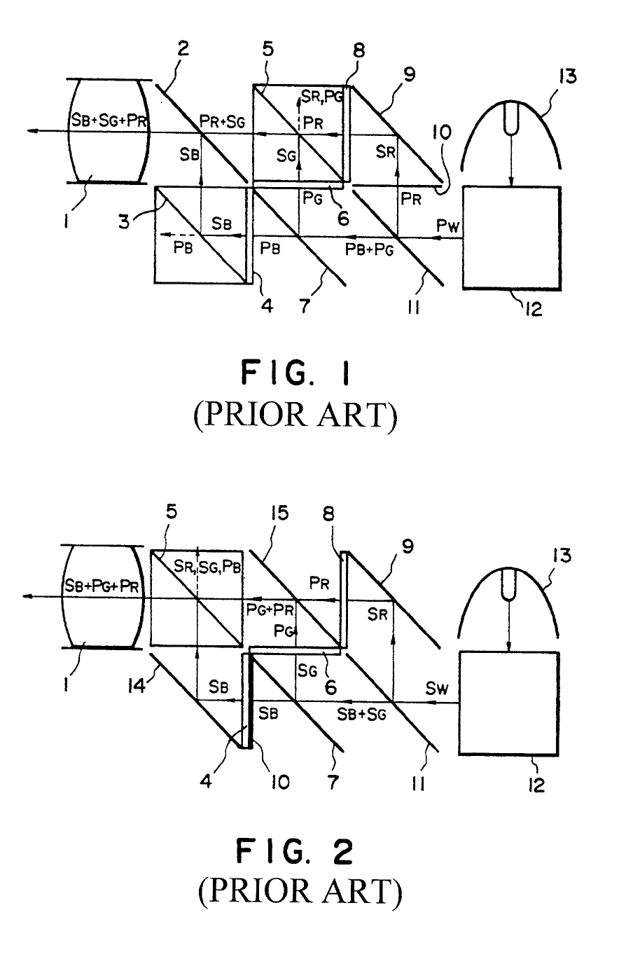

### DETAIL DESCRIPTION OF THE INVENTION

The liquid crystal projector of the invention having a high extinction ratio will be described with reference to the drawings. Thus, according to the principle, the contrast ratio of green light is increased in this invention.

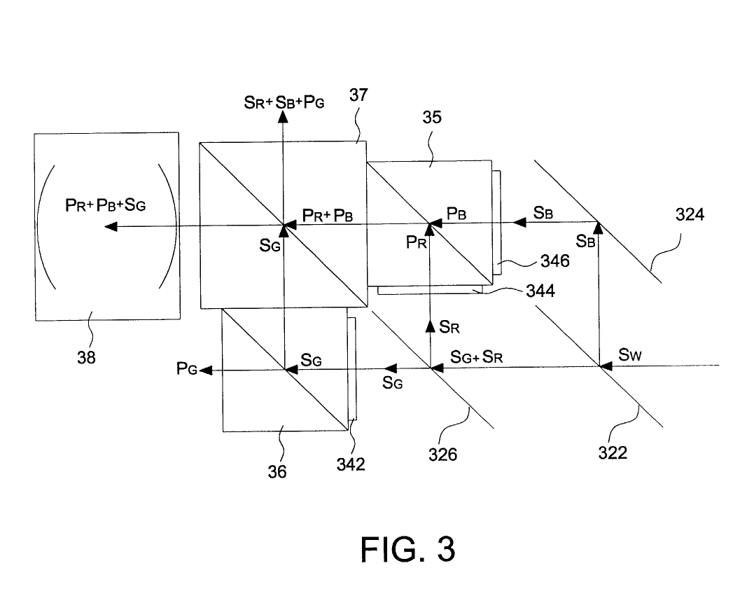

FIG. 3 is an optical architecture diagram showing a liquid crystal projector having a hight extinction ratio in accordance with a first embodiment of the invention. The main architecture of the embodiment simultaneously uses, in the beam-combining portion, two PS polarizing beam splitters for greatly increasing the contrast ratio of green light of the system. The optical system of the invention includes: a beam-splitting device consisting of a first dichroic mirror (DM) 322, a second dichroic mirror 326, and a reflection mirror 324; three transmission liquid crystal display modules (including a polarizer, LCD, an analyzer, and a λ/2 wavelength plate, hereinafter referred to as the “LCD module”) 342, 344 and 346; a dichroic prism 35; a first PS polarizing beam splitter 36; a second PS polarizing beam splitter 37; and a projecting lens 38.

As shown in FIG. 3, the S-polarized white light is separated into the S-polarized blue light S_{B}, and the S-polarized green light S_{G} and S-polarized red light S_{R} by way of the first dichroic mirror 322. Next, the S-polarized blue light S_{B} is reflected by the reflection mirror 324, travels toward the LCD module 342 in which the S-polarized blue light S_{B} is converted into the P-polarized blue light P_{B}, passes through the LCD module 342, and then travels toward the dichroic prism 35 (the λ/2 wavelength plate in the liquid crystal display module can ensure the incident light to the dichroic prism 35 to be P-polarized, thus the incident light can be either S or P-polarized). The S-polarized green light S_{G} and S-polarized red light S_{R} travel toward the second dichroic mirror 326, and then the reflective S-polarized red light S_{R} and the transmitted S-polarized green light S_{G} are generated. The reflected S-polarized red light S_{R} reflected by the second dichroic mirror 326 transmits through the LCD module 344 and is converted into the P-polarized red light P_{R}, and then travels toward the dichroic prism 35.

The dichroic prism 35 allows the red light to be reflected and the blue light to transmit therethrough. Therefore, the P-polarized red light P_{R} is reflected by the dichroic prism 35 and travels toward the second PS polarizing beam splitter 37, while the P-polarized blue light P_{B} transmits through the dichroic prism 35 and travels toward the second PS polarizing beam splitter 37. Next, after the S-polarized green light S_{G} transmitting through the second dichroic mirror 326 transmits through the LCD module 342, the S-polarized green light S_{G} is reflected by the first PS polarizing beam splitter 36 and then travels toward the second PS polarizing beam splitter 37, while the P-polarized green light P_{G} transmits through the first PS polarizing beam splitter 36. As a result, the contrast ratio of green light can be greatly increased by the first PS polarizing beam splitter 36. Finally, the P-polarized blue light P_{B} and P-polarized red light P_{R} travelling toward the second PS polarizing beam splitter 37 transmit through the second PS polarizing beam splitter 37, and travel toward the projecting lens 38. At the same time, the S-polarized green light S_{G} travelling toward the second PS polarizing beam splitter 37 is reflected by the second PS polarizing beam splitter 37 and travels toward the projecting lens 38.

In addition, because the S-polarized blue light S_{B} and S-polarized red light S_{R} travelling toward the second PS polarizing beam splitter 37 are reflected by the second PS polarizing beam splitter 37 without travelling toward the projecting lens 38, the contrasts of both blue light and red light are increased. At the same time, because the P-polarized green light P_{G} travelling toward the second PS polarizing beam splitter 37 transmits through the second PS polarizing beam splitter 37 without travelling toward the projecting lens 38, the contrast of green light is further increased.

Due to the response of human eyes with respect to green color is much higher than that of each of red and blue colors, when the contrast ratio of green light is increased, the contrast of the system is regarded as been greatly increased. Thereby, the contrast ratio of green light is increased by two polarizing beam splitters in this system, so that the contrast ratio of the system can be greatly increased. Thus, it should be noted that the wavelength of the light travelling toward the first PS polarizing beam splitter 36 must be in the range of green light in the first embodiment of the invention.

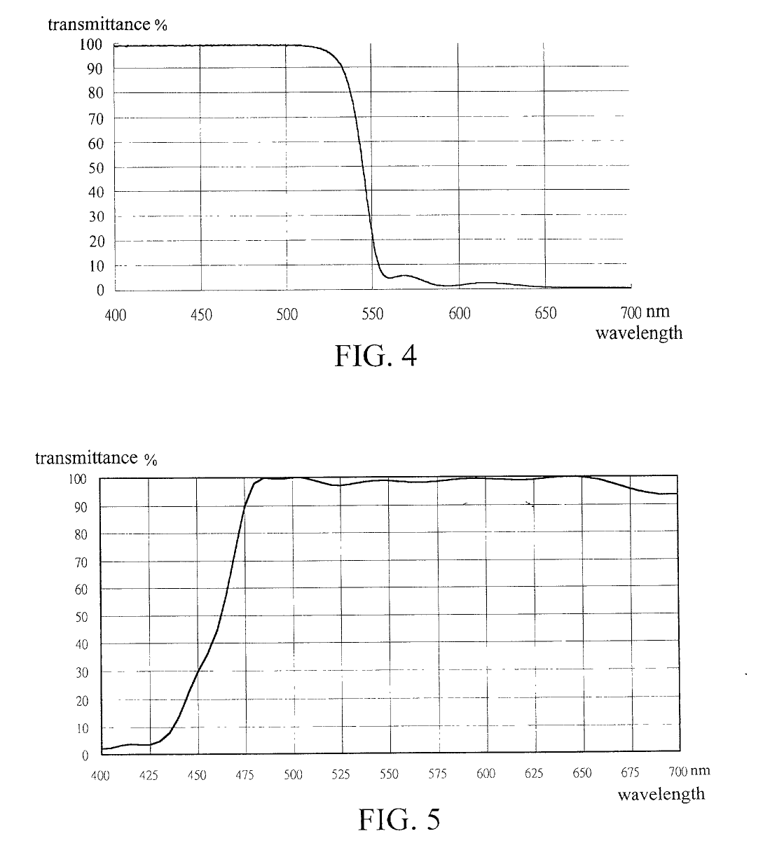

FIG. 4 is a graph showing the relationship between the wavelength and the transmittance of the dichroic prism in FIG. 3. According to the relationship between the wavelength and the color, the wavelength of blue light is about 400 to 500 nm, the wavelength of green light is about 500 to 590 nm, and the wavelength of red light is about 590 to 700 nm. The dichroic prism 35 of the invention allows the red light to be reflected and the blue light to transmit therethrough. As shown in FIG. 4, since the spectrum distribution ranges of blue light and red light are separated by that of green light, it is relatively possible to use the dichroic coating of the dichroic prism. That is, the allowable range of the position of dichroic wavelength for 50% transmittance (or reflectance) is quite wide (about 520 to 570 nm). In general, the allowable range of the wavelength position for 50% transmittance of the dichroic coating of adjacent two colors is equal to the middle wavelength ±5 nm. It is easy to cause the problem of insufficient color saturation or hue if the range is not satisfied. Therefore, the wavelength distribution of the invention is advantageous for the production of dichroic coating.

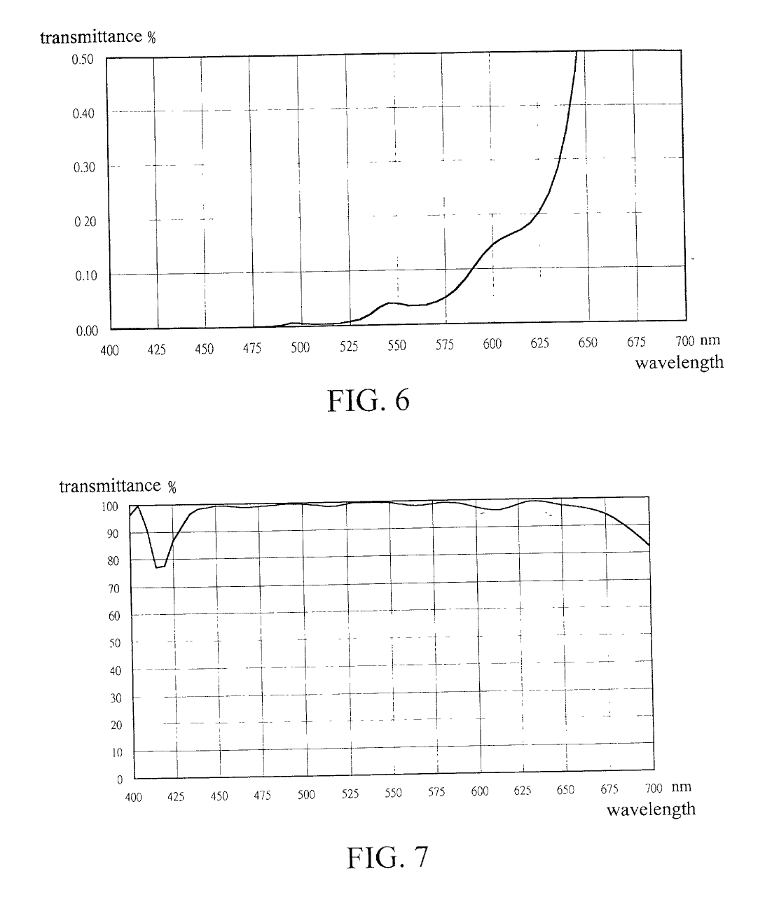

FIG. 5 is a graph showing the relationship between the wavelength of the first PS polarizing beam splitter in FIG. 3 and the transmittance of the P-polarized light. FIG. 6 is a graph showing the relationship between the wavelength of the first PS polarizing beam splitter in FIG. 3 and the transmittance of the S-polarized light. As shown in FIGS. 5 and 6, the first PS polarizing beam splitter 36 has a high transmittance with respect to the P-polarized green light, and a high reflectance or low transmittance (high extinction ratio, Tp/Ts) with respect to the S-polarized green light. Therefore, the contrast ratio of green light can be greatly increased by the first PS polarizing beam splitter 36.

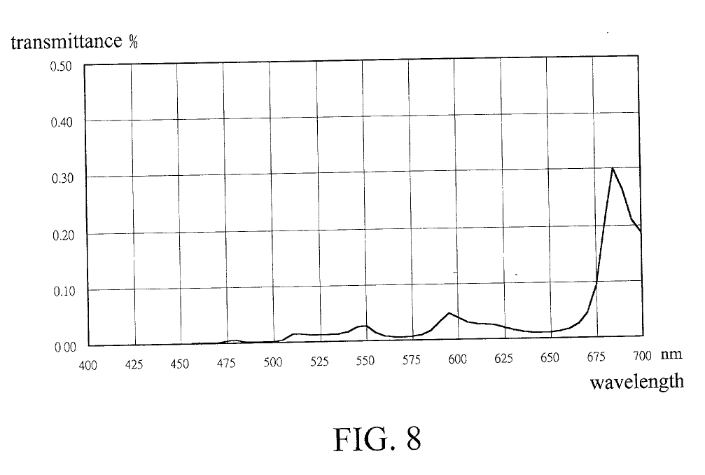

FIG. 7 is a graph showing the relationship between the wavelength of the second PS polarizing beam splitter in FIG. 3 and the transmittance of the P-polarized light. FIG. 8 is a graph showing the relationship between the wavelength of the second PS polarizing beam splitter in FIG. 3 and the transmittance of the S-polarized light. As shown in FIGS. 7 and 8, the second PS polarizing beam splitter 37 has a high transmittance with respect to the P-polarized light, and a high reflectance (high extinction ratio) with respect to the S-polarized light. Thus, the contrast ratio of green light can be further greatly increased by the second PS polarizing beam splitter 37 while the extinction ratios of blue light and red light also can be greatly increased by the second PS polarizing beam splitter 37. In addition, the setup wavelength of the second PS polarizing beam splitter 37 covers the range of all visible lights, while the setup wavelength of the first PS polarizing beam splitter 36 only needs to cover the range of the green light.

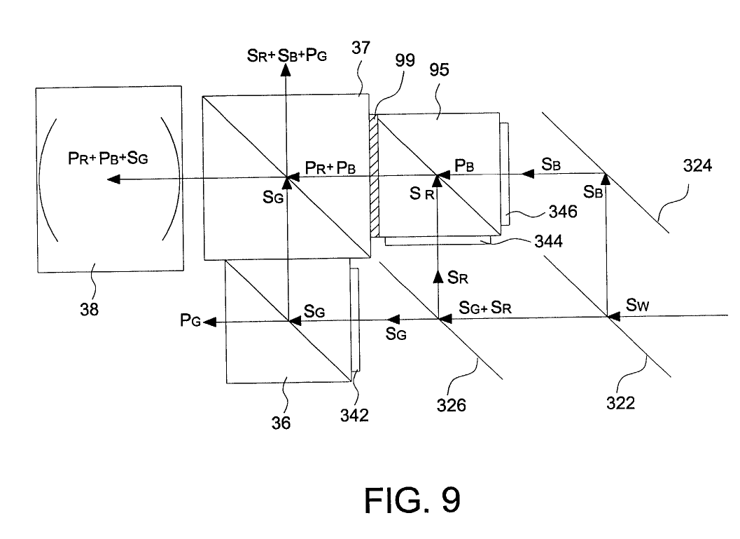

FIG. 9 is an optical architecture diagram showing another liquid crystal projector in accordance with a second embodiment of the invention. As shown in this figure, three PS polarizing beam splitters 95, 36, and 37 are used in the optical system of the second embodiment. Since the optical signals emitted from the third PS polarizing beam splitter 95 are the P-polarized blue light P_{B} and the S-polarized red light S_{R}, a color selector (CS) 99 is arranged between the third PS polarizing beam splitter 95 and the second PS polarizing beam splitter 37, in order to allow the P-polarized blue light P_{B} and S-polarized red light S_{R} to transmit through the second PS polarizing beam splitter 37. The function of the color selector 99 is to change the only polarized light with a predetermined wavelength. That is, in the embodiment, the function of the color selector 99 is to change the S-polarized red light S_{R} into the P-polarized red light P_{R}. Therefore, the P-polarized blue light P_{B} and S-polarized red light S_{R} pass through the color selector 99, and then become the P-polarized blue light P_{B} and the P-polarized red light P_{R}. According to the above-mentioned design, the contrast ratio and color saturation of each one of R, G, and B can be simultaneously increased. Furthermore, in this embodiment, the light paths of R, G, and B can be alternate light paths. There are no light paths limiting the green light as that in the first embodiment.

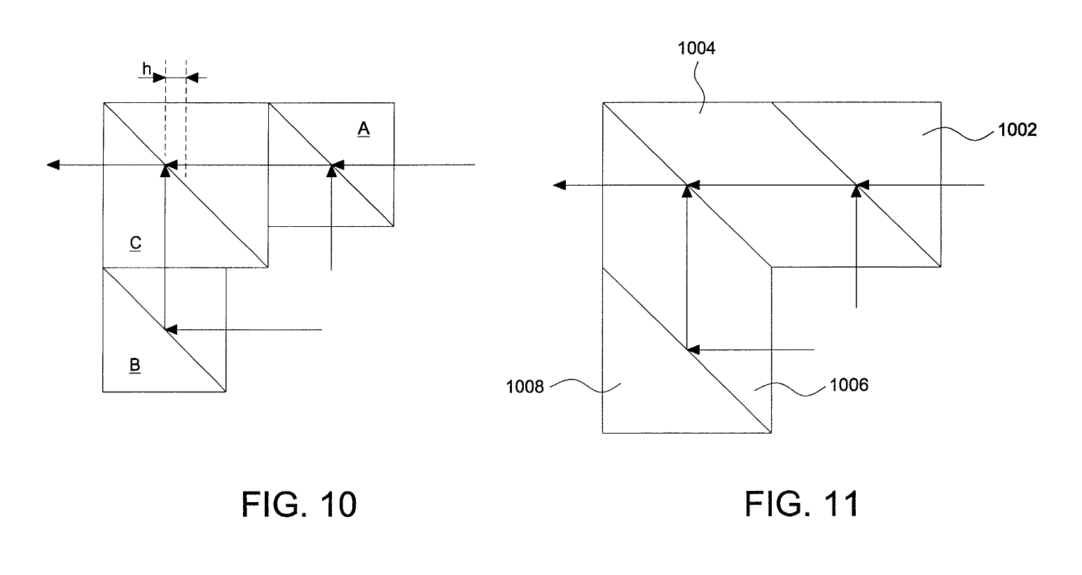

FIG. 10 is a schematic illustration showing modified arrangement architecture of the prisms of the invention. As shown in the figure, the geometric centers of the prism C and the prism B (A) may be non-symmetric. That is, it is not necessary for the prisms A and B to be arranged at the center position of the prism C, for example, the prisms A and B are arranged at an offset distance of h with respect to the center of the prism C. It is practical as long as the center positions of the prisms A and B are symmetrical with respect the prism C, which design is more advantageous to the arrangement of LCD because more sufficient space is allowed for mechanical adjustment. For example, the dichroic prism 35, first PS polarizing beam splitter 36, and second PS polarizing beam splitter 37 in the first embodiment can be arranged at the locations of prisms A, B, and C, respectively.

FIG. 11 is a schematic illustration showing modified arrangement architecture of the prisms of the invention. As shown in the figure, the prisms 35, 36, and 37 in the first embodiment can be formed by gluing four prisms 1002, 1004, 1006, and 1008, in order to save the manufacturing costs of the prism. The gluing surface between the prisms 1002 and 1004 can be a dichroic coating, the gluing surface between the prisms 1006 and 1008 can be a PS coating, and the gluing surface between the prisms 1004 and 1006 can be a PS coating.

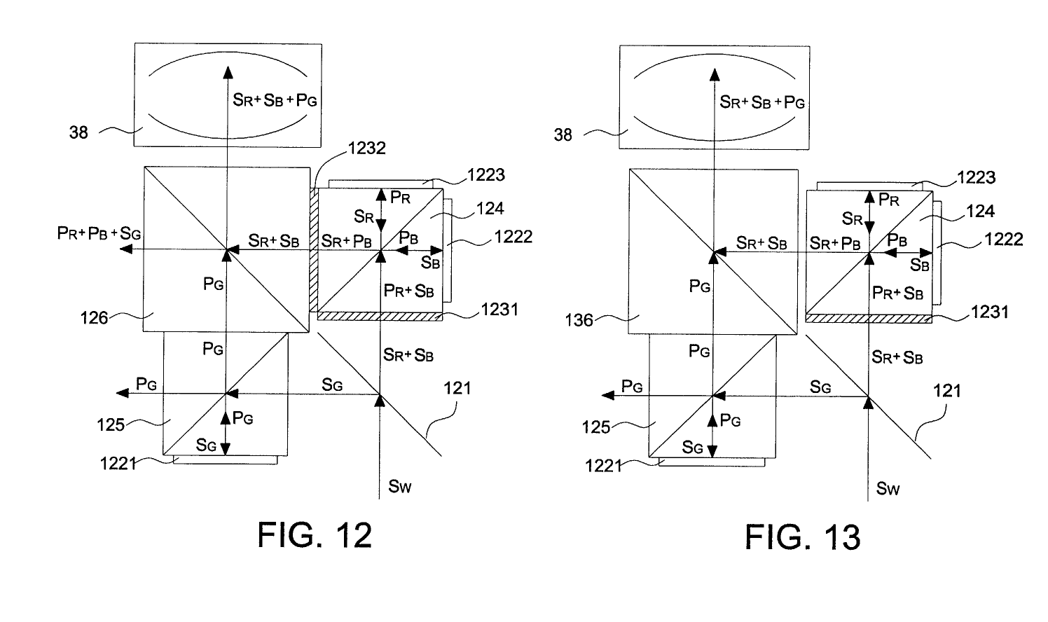

FIG. 12 is an optical architecture diagram showing another liquid crystal projector in accordance with a third embodiment of the invention. The optical system of the embodiment is applied to a reflective liquid crystal projector. As shown in the figure, the S-polarized white light S_{W} travels toward the dichroic mirror 121, and the reflective S-polarized green light S_{G} and the transmitted S-polarized red light S_{R} and S-polarized blue light S_{B} are then generated. The S-polarized green light S_{G} travels toward the second PS polarizing beam splitter 125, and is then reflected and travels to the reflective LCD module 1221. Next, the S-polarized green light S_{G} is reflected by the reflective LCD module 1221 and converted into the P-polarized green light P_{G} transmitting through the second PS polarizing beam splitter 125. The P-polarized green light P_{G} transmitting through the second PS polarizing beam splitter 125 further transmits through the third PS polarizing beam splitter 126 and travels toward the projecting lens 127. At this time, the S-polarized green light S_{G} is reflected by the third PS polarizing beam splitter 126 without travelling toward the projecting lens 127.

The S-polarized red light S_{R} and S-polarized blue light S_{B} travel toward the first color selector 1231 and are then converted into the P-polarized red light P_{R} and S-polarized blue light S_{B} both travelling toward the first PS polarizing beam splitter 124. The P-polarized red light P_{R} transmits through the first PS polarizing beam splitter 124, and is then reflected by the reflective LCD module 1223 and converted into the S-polarized red light S_{R}. The S-polarized red light S_{R} is reflected by the first PS polarizing beam splitter 124 and transmits through the second color selector 1232. The S-polarized blue light S_{B} is reflected by the first PS polarizing beam splitter 124 and travels to the reflective LCD module 1222. Then, the S-polarized blue light S_{B} is again reflected by the reflective LCD module 1222 and converted into the P-polarized blue light P_{B}. The P-polarized blue light P_{B} transmits through the first PS polarizing beam splitter 124, and then transmits through the second color selector 1232 and is converted into the S-polarized blue light S_{B}. Next, the S-polarized red light S_{R} and S-polarized blue light S_{B} are reflected by the third PS polarizing beam splitter 126 and travel to the projecting lens 127. At this time, the P-polarized red light P_{R} and P-polarized blue light P_{B} transmit through the third PS polarizing beam splitter 126 without travelling toward the projecting lens 127.

The optical system utilizes three PS polarizing beam splitters 124, 125, and 126 for greatly increasing the contrast ratio and color saturation of each of the R, G, and B colors simultaneously. In addition, the light paths of R, G, and B colors are alternate paths in this embodiment. If the incident light source is the P-polarized light, the positions of the reflective LCD module 1221 and the projecting lens 127 have to be changed, while the positions of the color selectors 1231 and 1232 have to be exchanged. At this time, the projecting signal to be shown is PR+PB+GS.

FIG. 13 is an optical architecture diagram showing another liquid crystal projector in accordance with a fourth embodiment of the invention. The embodiment are substantially the same as the third embodiment except for that the third PS polarizing beam splitter 126 in the third embodiment is replaced by the dichroic prism 136 in the fourth embodiment. Although the arrangement decreases the contrast ratio and color saturation, the cost of the second color selector can still be saved. The fourth embodiment is also similar to the embodiment shown in FIG. 11. That is, the first PS polarizing beam splitter, second PS polarizing beam splitter, and the dichroic prism can be formed by gluing four prisms.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A liquid crystal projector, comprising:
a beam-splitting device for supplying polarized lights of a first, a second and a third colors, which are polarized in predetermined directions, the wavelength of the second color ranging between the wavelength of the first color and the wavelength of the third color;
a first transmission liquid crystal display module for rotating the plane of polarization of the first color light in accordance with an input signal to generate a first image by the polarized light of the first color;
a second transmission liquid crystal display module for rotating the plane of polarization of the second color light in accordance with an input signal to generate a second image by the polarized light of the second color;
a third transmission liquid crystal display module for rotating the plane of polarization of the third color light in accordance with an input signal to generate a third image by the polarized light of the third color; and
a beam-combining mechanism for projecting the first, second and third images, the beam-combining mechanism comprising:
a first PS polarizing beam splitter for extracting a determined polarized light from the second liquid crystal display module;
a dichroic prism disposed at a location whereat the first and third polarized light from the first and the third liquid crystal display module intersect each other for reflecting the first polarized light from the first liquid crystal display module and transmitting there-through the third polarized light from the third liquid crystal display module, to extract a determined polarized light; and
a second PS polarizing beam splitter disposed at a location whereat the polarized light from first PS polarizing beam splitter and polarized light from the dichroic prism intersect each other, to extract a determined polarized light;
wherein the second color passes through two PS polarizing beam splitters for increasing the contrast ratio and color saturation of the color.

2. The liquid crystal projector according to claim 1, wherein the second color is green.

3. The liquid crystal projector according to claim 1, wherein the geometric centers of the first PS polarizing beam splitter and the dichroic prism are non-symmetric with respect to the geometric center of the second PS polarizing beam splitter.

4. The liquid crystal projector according to claim 1, wherein the first PS polarizing beam splitter, the dichroic prism, and the second PS polarizing beam splitter are formed by gluing four prisms.

5. A liquid crystal projector, comprising:
a beam-splitting device for supplying polarized lights of a first, a second and a third colors, which are polarized in predetermined directions;
a first transmission liquid crystal display module for rotating the plane of polarization of the first color light in accordance with an input signal to generate a first image by the polarized light of the first color;
a second transmission liquid crystal display module for rotating the plane of polarization of the second color light in accordance with an input signal to generate a second image by the polarized light of the second color;
a third transmission liquid crystal display module for rotating the plane of polarization of the third color light in accordance with an input signal to generate a third image by the polarized light of the third color; and
a beam-combining mechanism for projecting the first, second and third images, the beam-combining mechanism comprising:
a first PS polarizing beam splitter for extracting a determined polarized light from the second liquid crystal display module;
a second PS polarizing beam splitter disposed at a location whereat the first and third polarized light from the first and the third liquid crystal display module intersect each other for reflecting the first polarized light from the first liquid crystal display module and transmitting there-through the third polarized light from the third liquid crystal display module, to extract a determined polarized light; and
a color selector for converting the polarization of one color of the determined polarized lights from the second PS polarizing beam splitter; and
a third PS polarizing beam splitter disposed at a location whereat the polarized light from first PS polarizing beam splitter and polarized light from the color selector intersect each other, to extract a determined polarized light.

6. The liquid crystal projector according to claim 5, wherein the geometric centers of the first PS polarizing beam splitter and the second PS polarizing beam splitter are non-symmetric with respect to the geometric center of the third PS polarizing beam splitter.

7. A liquid crystal projector, comprising:
a beam-splitting device for supplying a polarized light of a first color with a first set of wavelength, and a polarized light of a second and third colors with a second set of wavelengths;
a first reflective liquid crystal display module for rotating the plane of polarization of the first color light in accordance with an input signal to generate a first image by the polarized light of the first color;
a second reflective liquid crystal display module for rotating the plane of polarization of the second color light in accordance with an input signal to generate a second image by the polarized light of the second color;
a third reflective liquid crystal display module for rotating the plane of polarization of the third color light in accordance with an input signal to generate a third image by the polarized light of the third color; and
a first PS polarizing beam splitter for supplying the polarized light with the first set of wavelength to the first reflective liquid crystal display module, and outputting the polarized light of the first image;
a first color selector for changing the polarization of one color in the second set of wavelengths;
a second PS polarizing beam splitter for supplying the polarized light of the second color outputted from the first color selector to the second reflective liquid crystal display module, supplying the polarized light of the third color outputted from the first color selector to the third reflective liquid crystal display module, and outputting the polarized lights of the second image and the third image;
a second color selector for changing the polarization of one color in the second set of wavelengths; and
a third PS polarizing beam splitter for outputting the polarized lights of the first image, second image, and third image to a projecting lens.

8. The liquid crystal projector according to claim 7, wherein the geometric centers of the first PS polarizing beam splitter and the second PS polarizing beam splitter are non-symmetric with respect to the geometric center of the third PS polarizing beam splitter.

9. A liquid crystal projector, comprising:
a beam-splitting device for supplying a polarized light of a first color with a first set of wavelength, and a polarized light of a second and third colors with a second set of wavelengths;
a first reflective liquid crystal display module for rotating the plane of polarization of the first color light in accordance with an input signal to generate a first image by the polarized light of the first color;
a second reflective liquid crystal display module for rotating the plane of polarization of the second color light in accordance with an input signal to generate a second image by the polarized light of the second color;
a third reflective liquid crystal display module for rotating the plane of polarization of the third color light in accordance with an input signal to generate a third image by the polarized light of the third color; and
a second PS polarizing beam splitter for supplying the polarized light of the second color outputted from the first color selector to the second reflective liquid crystal display module crystal display module for generating a third image from an incident polarized light according to the input signal;
a first PS polarizing beam splitter for supplying the polarized light with the first set of wavelength to the first reflective liquid crystal display module, and outputting the polarized light of the first image;
a color selector for changing the polarization of one color in the second set of wavelengths;, supplying the polarized light of the third color outputted from the first color selector to the third reflective liquid crystal display module, and outputting the polarized lights of the second image and the third image; and
a dichroic prism for outputting the polarized lights of the first image, second image, and third image to a projecting lens.

10. The liquid crystal projector according to claim 9, wherein the geometric centers of the first PS polarizing beam splitter and the second PS polarizing beam splitter are non-symmetric with respect to the geometric center of the dichroic prism.

11. The liquid crystal projector according to claim 9, wherein the first PS polarizing beam splitter, dichroic prism, and second PS polarizing beam splitter are formed by gluing four prisms.
